(19) United States
(12) Patent Application Publication
(10) Pub. No.: US 2009/0217862 A1
(43) Pub. Date: Sep. 3, 2009

(54) DIRECTIONAL ROPE WITH TACTILE INDICATORS

(76) Inventor: ROBERT ZEKE CHRISTENSEN, BOISE, ID (US)

Correspondence Address: DYKAS, SHAVER & NIPPER, LLP, P.O. BOX 877, BOISE, ID, 83701-0877, US

(21) Appl. No.: 12/395,063

(22) Filed: Feb. 27, 2009

Related U.S. Application Data
(60) Provisional application No. 61/032,335, filed on Feb. 28, 2008.

(51) Int. Cl. G01D 21/00

(52) U.S. Cl. 116/205

(57) ABSTRACT

A directional rope with tactile indicators, the rope configured for denoting to a fire-fighter the escape route from a dark or smoked filled environment that has little or no visibility.

### PRIORITY/CROSS-REFERENCE TO RELATED APPLICATIONS

This application claims the priority date of the provisional application entitled “Directional Rope with Tactile Indicators” filed by Robert Zeke Christensen on Feb. 28, 2008 with application Ser. No. 61/032,335, the disclosure of which is incorporated by reference.

### FIELD OF THE INVENTION

The present invention relates generally to emergency escape assistive devices, and more particularly, to devices, used by fire-fighters, which indicates an escape route out of a building.

### BACKGROUND OF THE INVENTION

When fire-fighters enter a burning building and are preoccupied with saving lives, it is easy for them to get disoriented and lose their sense of direction, particularly in conditions of darkness and heavy smoke. Fire-fighters typically utilize one or more safety ropes when battling a fire. The fire-fighters will secure a first end of such a safety rope in a safe area, such as the entrance to the building. The one or more of the fire-fighters will then drag the rope with them through the building, thereby leaving a trail (the rope) which can be followed (by others) back to the safe area. As the fire-fighters search the building and battle the fire, they will typically fan out from this safety line, search a room/area, and then return to the safety line. However, a major problem exists when a fire-fighter or other individual, often in the dark, finds the safety rope, namely how to determine which direction down the rope leads to safety and which direction leads further into the building/structure.

The present invention is a rope having an integral tactile indicator which allows a fire-fighter or other individual to feel the rope, preferably without removing his/her safety gloves, and determine which direction leads to safety.

### BRIEF DESCRIPTION OF THE DRAWINGS

FIG. 1 is a partial view of a first embodiment.

FIG. 2 is a perspective view of a second embodiment, shown installed on a length of rope.

FIG. 3 is a perspective view of one of the devices of FIG. 2.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The purpose of the Abstract of the Disclosure is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

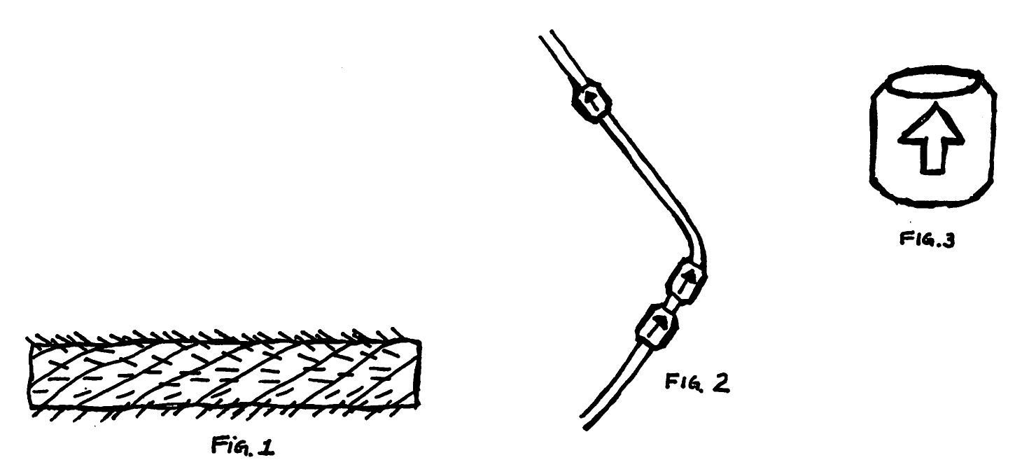

Disclosed is directional rope with tactile indicators for use as an emergency escape assistive device. Two different embodiments are shown in the drawings, namely the embodiment having stiff fibers which extend from the rope at an angle indicating a direction (FIG. 1) and the embodiment having a plurality of direction indicating bands, or other indicators, affixed to the rope (FIGS. 2 and 3).

Preferably, the directional rope is stored in acceptable rope bags and would come in various lengths and diameters. The lengths might range from about fifty feet to about two-hundred feet. The diameter could vary from about one-quarter inch to about three-quarter inches. However, other lengths and diameters are possible.

Referring initially to the embodiment of FIG. 1, the fibers would radiate outwards from the outer surface of the rope. They could be formed within the rope, be woven into the outer surface of the rope, be inserted into the rope, etc. The fibers are preferably stiff enough to maintain a substantially constant angle with the surface of the rope. The fibers effectively forming what feels like a stiff hair-brush like surface surrounding the rope. Preferably, bristly surface would be rough to the touch when petted in a first direction (the direction away from the safety area) and would not be rough to the touch when petted in the second direction (the direction away from the safety area). In another embodiment, the bristles could be oriented in multiple directions for creating a version of the rope that has an increased friction in both directions, particularly useful where the rope needs to be less prone to slippage, for instance, technical rescue, ladder halyard, pulleys, etc.

It is preferred that these fibers be fire-resistant. The fire-resistant fibers may be made from any fibrous fire-resistant material, including but not limited to polytetrafluoroethylene.

The fibers define an angle with the outer surface of the rope. The magnitude of this angle is preferably from zero to about eighty degrees, and more preferably from about twenty degrees to about seventy degrees. Even more preferably, the magnitude of angle is from about thirty degrees to about sixty degrees. Most preferably, the magnitude of angle is from about forty degrees to about fifty degrees.

The configuration and structure of the fibers on the rope are such that a fire-fighter, even one suffering some disorientation and working in a dark, smoke-filled atmosphere, is able to ascertain the direction of the exit to safety by passing a hand over and along the outer surface of the rope. Preferably, this being done without the fire-fighter having to remove his/her protective glove(s), to feel which direction is “with the grain” of the fibers, and which direction is “against the grain” of the fibers. By knowing whether “with” or “against” represents the direction to safety, the fire-fighter (or other individual) can follow the rope to egress out of the building.

Referring now to FIGS. 2 and 3, shown is a second embodiment of the present invention. This embodiment showing a rope having tactile indicator bands. These tactile indicator bands preferably fit tightly over the rope. In the preferred embodiment, these bands are flexible enough to be stretched over the rope but will also maintain size of opening to fit snug around the rope. These bands could be made of any material, including but not limited to metal, plastics and rubber. The bands could be sold independent of the rope.

These indicator bands could serve two purposes. A first purpose is so a user can place them on the rope to mark distances. For instance, over a 200 foot section of rope a single tactile indicator may be placed every 25 feet (one placed at the 25 foot line, two placed at the 50 foot line, three at the 75 foot line, etc.). The second purpose would be to show direction, for instance having an integral arrow which points to the exit or safety. Preferably, the indicator bands also will also glow in the dark.

In another embodiment, a fire resistant rope is provided which comprises a core formed of high tensile strength fibers and a jacket formed of high temperature resistant fibers, where the jacket covers the core. The core comprises a plurality of strands, where each strand comprises a plurality of yarns and each yarn comprises a plurality of high tensile strength fibers. The jacket comprises a plurality of strands, where each strand comprises a plurality of yarns and each yarn comprises a plurality of high temperature resistant fibers. Optionally, a fire retardant material may be applied to the rope.

While there is shown and described the present preferred embodiment(s) of the invention, it is to be distinctly understood that this invention is not limited thereto but may be variously embodied to practice within the scope of this disclosure. From the foregoing description, it will be apparent that various changes may be made without departing from the spirit and scope of the invention as defined by this disclosure.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A directional rope, comprising: a rope; directional means for determining, in a dark and smoke-filled environment caused by a fire, the direction, a plurality of fire-resistant fibers attached to the outer surface of the rope, the fibers characterized as thereby enabling a person to escape from the fire by following the rope in a direction toward the end of the rope more distant from the fire; defining an acute angle with the surface of the rope; being inclined toward and pointing in the same direction as other fibers; being sufficiently stiff to maintain a substantially constant angle with the surface of the rope; and effectively forming a brush surface surrounding the rope, the brush surface characterized as being smooth to touch in one direction, and rough to touch in the opposite direction.

2. The directional rope of claim 1, wherein the fibers are made from material with a minimum 350 degree melting temperature.

3. The directional rope of claim 1, wherein the fibers define an angle of from about thirty to about sixty degrees with the outer surface of the rope.

4. In a directional rope: defining an acute angle with the surface of the rope; being inclined toward and pointing in the same direction; and being sufficiently stiff to maintain a substantially constant angle with the surface of the rope.
